(19) United States
(12) Patent Application Publication
(10) Pub. No.: US 2010/0157057 A1
(43) Pub. Date: Jun. 24, 2010

(54) APPARATUS AND METHOD FOR DETECTING PERSON

(75) Inventors: Eul Gyoon Lim, Daejeon (KR); Dae Hwan Hwang, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONIC AND TELECOMMUNICATIONS RESEARCH INSTITUTE, Daejeon (KR)

(21) Appl. No.: 12/508,176

(22) Filed: Jul. 23, 2009

(30) Foreign Application Priority Data
Dec. 22, 2008 (KR) 10-2008-0131281

(51) Int. Cl. H04N 7/18

(52) U.S. Cl. 348/148; 348/E07.085; 901/47

(57) ABSTRACT

Provided is a person detecting apparatus and method in an intelligent mobile robot. The person detecting apparatus includes a camera, an observation system status input unit, an encoding unit, a decoding unit, and a person detection unit. The camera is mounted on a robot to output image information. The observation system status input unit determines whether the robot or the camera is in motion. The encoding unit receives the image information to output a bit stream including mode information. The decoding unit decodes the bit stream, extracts a block mode value of each macro block, and stores the same in a two-dimensional array. The person detection unit outputs detection information about a moving person using the determination information provided from the observation system status input unit and the block-mode two-dimensional array provided from the decoding unit.

### CROSS-REFERENCE TO RELATED APPLICATIONS

This application claims priority under 35 U.S.C. §119 to Korean Patent Application No. 10-2008-0131281, filed on Dec. 22, 2008, the disclosure of which is incorporated herein by reference in its entirety.

### TECHNICAL FIELD

The present disclosure relates to an apparatus and method for an intelligent mobile robot, and in particular, to an apparatus and method for detecting the presence and location of a person by an intelligent mobile robot.

### BACKGROUND

An intelligent mobile robot recognizes peripheral situations by interpreting an image received from a camera mounted thereon. That is, the intelligent mobile robot detects the presence of a person image in an image, recognizes the person using the face of the person, and provides a service for each person. Herein, a face detector using an algorithm such as Adaboost may be directly applied to an image. This, however, requires the repeated performance of a complex arithmetic operation. Therefore, a simple algorithm is used first to detect the presence and location of a person before the application of the face detector.

Related art technologies for detection of the presence and location of a person in an image can be generally classified into the following two types.

The first technology uses brightness and color information for each pixel in an image to detect a skin color region, and uses edge information to detect an ellipse corresponding to the shape of a head, thereby detecting a candidate face region. The first technology can also be used in a robot that is moving or panning/tilting a camera. However, the first technology is computation-intensive to the extent that a general PC platform can detect a QVGA-resolution image about 6 to 8 times per second.

The second technology detects the motion of a person by using a motion vector (or an optical flow) that is generated when a series of camera pictures are encoded into MPEG4 moving pictures. The second technology uses the following methods.

The first method (See Korean Pat. Appln. No. 2007-0113682) uses a hardware encoder for the standard moving picture format. The first method can easily obtain a motion vector and detect the presence and location of a person, which is moving in front of a stationary robot, in real time even in a low-performance embedded system.

The second method (See “Human Tracking Using The Temporally Averaged Silhouette With An Active Camera”, Tetsuji Haga et al., System And Computing In Japan, 2006. Vol. 37 No. 12, 66 p-81 p) is a motion vector-based method that continues to trace the location of a person, which is detected by a still camera, even in a situation where the camera is in motion. However, the second method must detect the location of a person first in a state that the camera comes to stop.

The third method (See Japanese Pat. No. 343524) detects the presence of a moving object in a state that a camera is in motion. However, in order to detect the location of a moving object, the third method must detect the region while segmenting a screen.

The fourth method (See “Moving Object Detection From MPEG Video System”, Akio Yoneyama et al., System And Computing In Japan, 1999. Vol. 30 No. 13, 1776 p-1786 p) calculates the correlation between motion vectors to detect the presence and location of a person, when a camera is panning/tilting or a robot is moving. However, the fourth method is difficult to implement in real time in an embedded system that is limited in the floating-point arithmetic performance.

As described above, in the related art technologies for detection of the presence and location of a person in an image, a camera must pan/tilt or a robot itself must move, if there is no person image in a picture. In this case, the first and second methods of the second technology may not be used because the panning/tilting of the camera or the movement of the robot should stop at any time. Thus, only the first technology and the third and fourth methods of the second technology can be used.

However, it is difficult for the intelligent mobile robot to mount a PC-level computational performance for marketability. Therefore, the first technology and the third and fourth methods of the second technology are difficult to use in the intelligent mobile robot. Thus, the related art technologies for detection of the presence and location of a person have many limitations in the case where the intelligent mobile robot actively detects a person to provide a service.

That is, it is very unnatural that a service robot momentarily stops movement or panning/tilting to detect a target person. Also, it is undesirable in terms of the battery duration that the service robot performs a high-level arithmetic operation to eliminate the unnaturalness. Furthermore, it is undesirable in terms of the consumer's price that the service robot has an additional sensor for such a function.

### SUMMARY

Accordingly, the present disclosure provides a person detecting apparatus and method that enables an intelligent mobile robot, which is moving or panning/tilting a camera to detect a person, to detect whether a person is present within its vision and the location of the person.

According to an aspect, a person detecting apparatus is provided. The person detecting apparatus includes a camera, an observation system status input unit, an encoding unit, a decoding unit, and a person detection unit. The camera is mounted on a robot to output image information. The observation system status input unit determines whether the robot or the camera is in motion. The encoding unit receives the image information to output a bit stream including mode information. The decoding unit decodes the bit stream, extracts a block mode value of each macro block, and stores the same in a two-dimensional array. The person detection unit outputs detection information about a moving person using the determination information provided from the observation system status input unit and the block-mode two-dimensional array provided from the decoding unit.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram of a person detecting apparatus according to an exemplary embodiment;

FIGS. 2 and 3 are graphs illustrating the determination of presence of a moving person by a decoding unit used in the person detecting apparatus according to an exemplary embodiment;

FIGS. 4 and 5 are graphs illustrating the determination of location of a person by a person location extracting unit used in the person detecting apparatus according to an exemplary embodiment; and

FIG. 6 is a flow diagram illustrating a person detecting method according to an exemplary embodiment.

### DETAILED DESCRIPTION OF EMBODIMENTS

Hereinafter, specific embodiments will be described in detail with reference to the accompanying drawings.

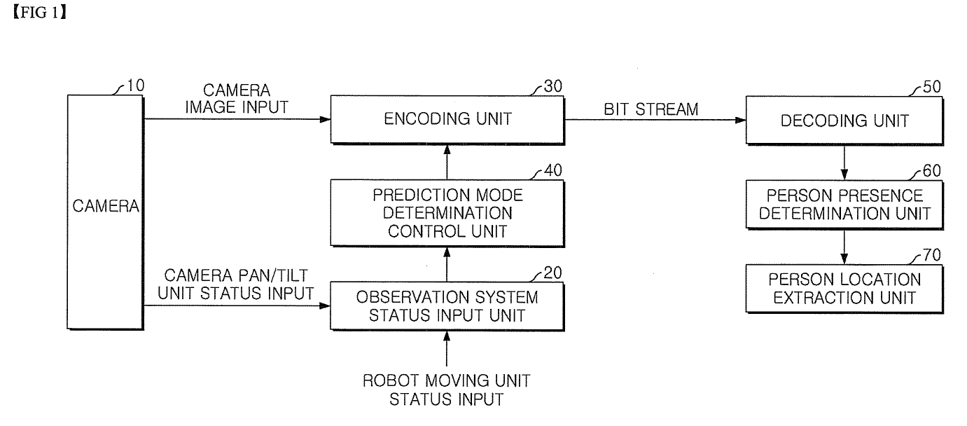

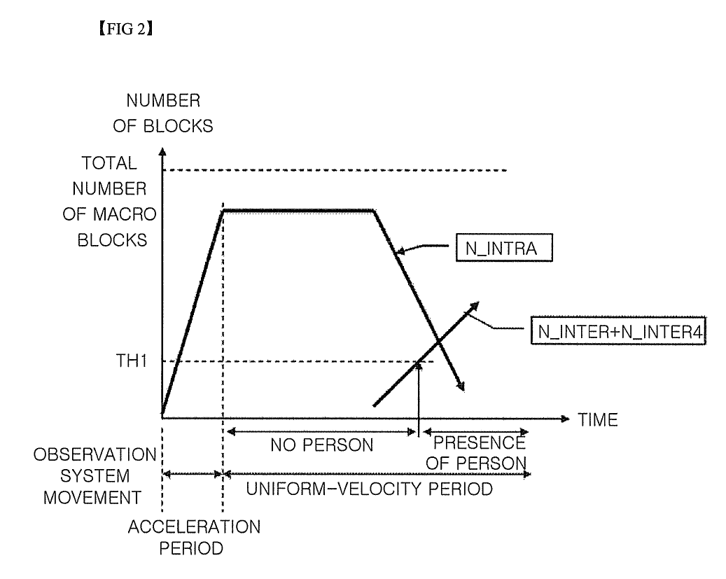

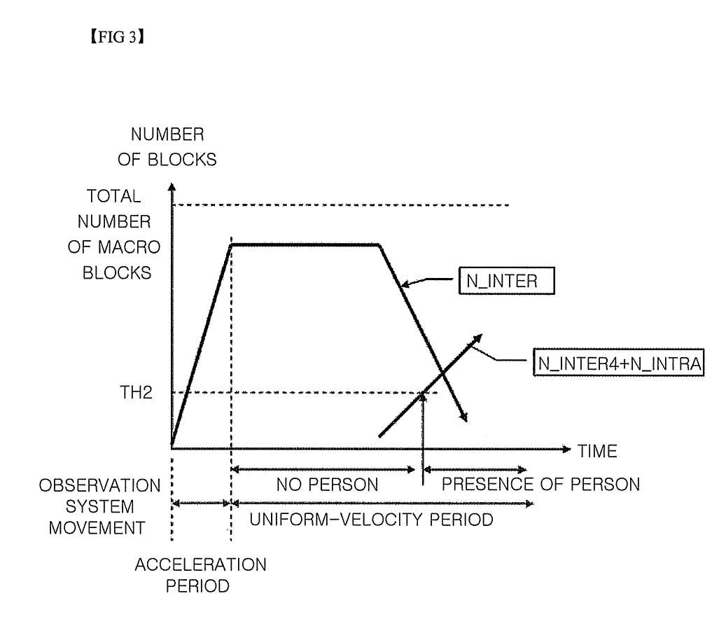

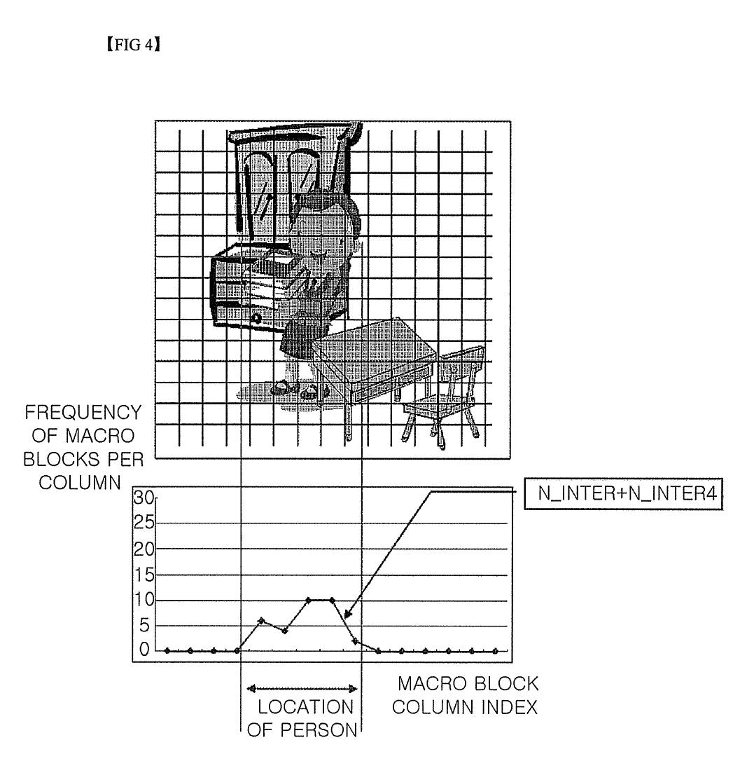

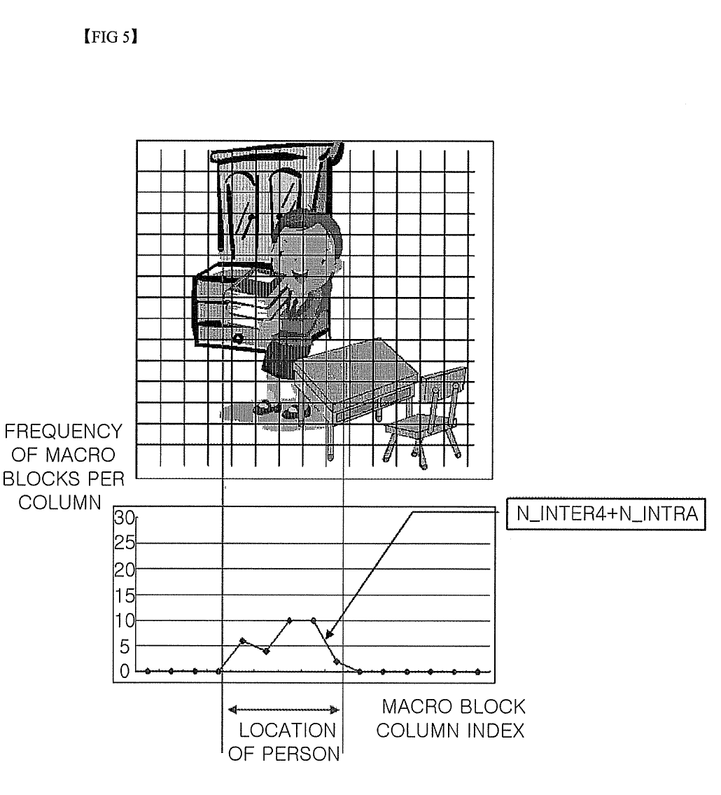

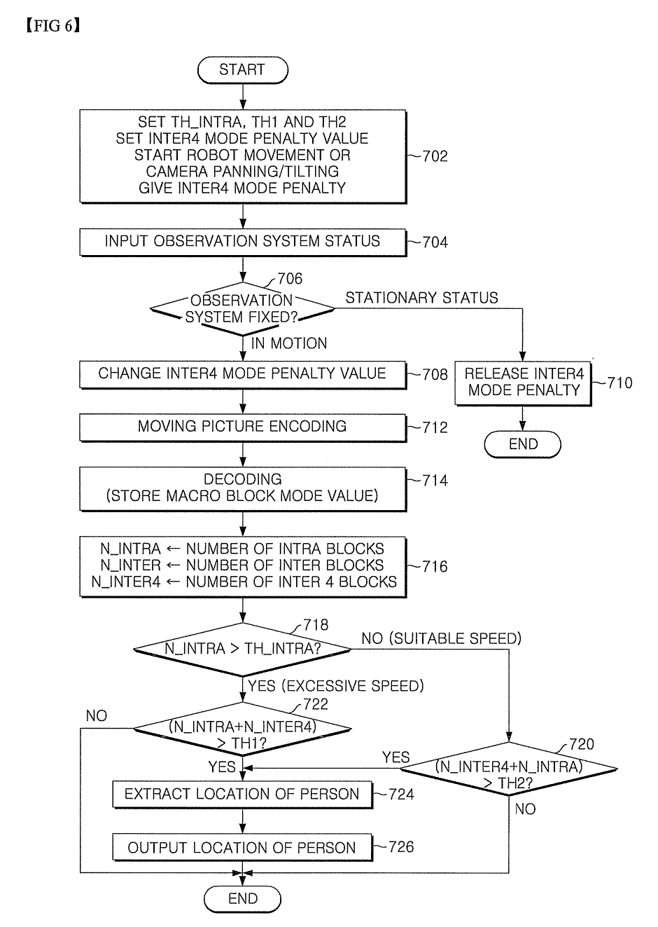

FIG. 1 is a block diagram of a person detecting apparatus according to an exemplary embodiment. FIGS. 2 and 3 are graphs illustrating the determination of the presence of a moving person by a decoding unit used in the person detecting apparatus according to an exemplary embodiment. FIGS. 4 and 5 are graphs illustrating the determination of the location of a person by a person location extracting unit used in the person detecting apparatus according to an exemplary embodiment. FIG. 6 is a flow diagram illustrating a person detecting method according to an exemplary embodiment.

Referring to FIG. 1, a person detecting apparatus according to an exemplary embodiment includes a camera 10, an observation system status input unit 20, a block-based encoding unit 30 supporting two or more prediction modes, a prediction mode determination control unit 40, a decoding unit (or block mode acquisition unit) 50, a person presence determination unit 60, and a person location extraction unit 70.

The camera 10 is a video camera that is mounted on a robot to output image information in a format to be processed by the encoding unit 30. For example, a CMOS sensor, a CCD camera, or a USB camera may be used as the camera 10.

The observation system status input unit 20 receives information, which m ay affect the viewing direction and the location of a camera origin point, to output information about whether the camera origin point or the viewing direction has changed.

The encoding unit 30 receives a camera image to output a bit stream, including mode information, on a frame basis.

The encoding unit 30 segments an image of a frame into macro blocks with a predetermined size to perform an encoding operation on a macro block basis. When a macro block is encoded, if it is similar to a specific region of the previously encoded image, the specific region is taken as a prediction value and only a difference between the prediction value and the current region is encoded. This is called a prediction mode. If an image region to be taken as the prediction value is present in the current frame, it is called an INTRA prediction mode, and if the image frame is present not in the current frame but in a reference frame, it is called an INTER prediction mode. A macro block encoded in an INTER prediction mode has a motion vector value indicating the location of the reference region. There is a case where it is more efficient to perform an encoding operation newly without reference to anything. This is called an INTRA mode.

Among the INTER prediction modes, an INTER4 prediction mode segments each macro block into four blocks and uses different block values in a reference frame as prediction values for the respective blocks, in which each macro block has four motion vectors. The recent moving picture standard such as H.264 segments a macro block of 16×16 pixels not into quarters but into two partitions of 8×16 pixels or 16×8 pixels and segments each partition into sub macro block partitions of 8×8, 4×8, 8×4 and 4×4 pixels. This is called tree structured motion compensation.

Hereinafter, for simplicity of notation, a macro block, which is encoded in a tree structured motion compensation mode or an INTER4 prediction mode to have two or more motion vectors, will be referred to as an INTER4 block. A macro block, which is encoded in an INTER prediction mode to have only one motion vector, will be referred to as an INTER block. A macro block encoded in an INTRA mode will be referred to as an INTRA block.

Meanwhile, macro blocks present at the boundary of a moving person image tend to be segmented into sub macro blocks of smaller size.

If all the macro blocks in a frame are encoded in an INTRA mode or an INTRA prediction mode, the frame is called an I frame, an I picture, or an I Video Object Plane (VOP). If a frame is encoded with reference to the previous frame, the frame is called a P frame, a P picture, or a P VOP. If a frame is encoded with reference to the previous frame and the next frame, the frame is called a B frame, a B picture, or a B VOP.

Even though a frame is encoded into a P frame and a B frame, the macro block may be encoded in an INTRA mode or an INTRA prediction mode, if it is efficient to newly encode any macro block in the frame. Also, even if a reference frame is used, it may also be encoded in an INTER prediction mode or an INTER4 prediction mode. A normal moving picture standard predefines an objective function capable of being used to determine a mode, encodes a macro block in various modes, compares the respective objective function values, and uses the mode minimizing the amount as the mode of the macro block. The objective function may be the amount of a residual signal according to the prediction value or the amount of an output bit stream, but the structure of the objective function may vary depending on the moving picture standards.

Meanwhile, moving picture standard conditions among encoding conditions used in the present invention are as follows.

The encoding unit 30 according to the present invention is a block-based moving picture hardware encoder that supports an INTRA mode and two or more prediction modes (e.g., an INTER4 prediction mode including a tree structured motion compensation mode and an INTER prediction mode). It may be a moving picture encoder according to the standard such as MPEG4, H.264, some H.263 (e.g., ITU-T H.263 Annex F supporting Advanced Prediction Mode), or H.263+. The conventional moving picture standards, such as H.261, MPEG2 and normal H.263, are difficult to use because they generate only one motion vector per macro block of 16×16 pixels.

Next, a mode penalty setting function among encoder setting interface conditions is as follows.

The encoding unit 30 according to the present invention must be able to add predetermined penalties (constant values) to an objective function value of a specific mode so that one of an INTER block and an INTER4 block may occur more frequently than the other. Because a normal moving picture encoder (encoding unit) selects a mode with a smaller objective function value, a mode given a penalty occurs more rarely than other modes.

Next, an I/P/B frame selecting function among the encoder setting interface conditions is as follows.

The encoding unit 30 according to the present invention must be able to select a frame to be currently encoded among I, P and B frames. The present invention is set to encode only a P frame.

Next, a CIR control function among the encoder setting interface conditions is as follows.

In general, a restored picture may be incomplete due to an error that occurs in normal moving picture using processes including storing, reading, transmitting, and receiving. Thus, in order to automatically recover such an error, the moving picture encoding unit according to the present invention has a Cyclic Intra Refresh (CIR) function that cyclically generates an INTRA block in P and B frames to forcibly update each macro block in a predetermined cycle. That is, the moving picture encoding unit according to the present invention must be able to control the number of INTRA blocks to be generated per frame by the CIR function, and the present invention is characterized in that the value is minimized.

The prediction mode determination control unit 40 controls a tendency to generate an INTER block and an INTER4 block. That is, if it is determined by the observation system status input unit 20 that an image is in a panning or tilting status (i.e., an up/down or right/left movement status) due to robot movement and camera direction control and that the speed is capable of INTER prediction mode encoding, a mode penalty value of the encoding unit 30 is changed such that the INTER4 block occurs as rarely as possible. If it is determined by the observation system status input unit 20 that an image is not in a panning or tilting status, a mode penalty value of the encoding unit 30 is set such that the INTER4 block is normally generated to achieve an optimal moving picture compression ratio.

The decoding unit 50 decodes the bit stream outputted from the encoding unit 30 on a frame basis, extracts a block mode value of each macro block, and stores the same in a two-dimensional array. The decoding unit 50 may be a moving picture software decoder. Herein, the moving picture software decoder does not need to perform a CPU-consuming operation such as inverse DCT because it does not need to restore a complete image.

The person presence determination unit 60 determines whether a moving person image is present in a current image using the block-mode two-dimensional array obtained by the decoding unit 50. Herein, the current image is an image whose background is being changed.

First, with reference to FIG. 2, a description will be given of a method for the person presence determination unit 60 to determine whether a person is present if a robot moving speed or a camera panning/tilting (up/down or right/left movement) speed is high.

If a robot moving speed or a camera panning/tilting speed is very high, all the macro blocks are encoded not in a prediction mode but in an INTRA block. However, in such a situation, if a moving person enters the camera's vision and a corresponding portion moves in the opposite direction of the vision movement, the corresponding portion may be encoded in an INTER block or an INTER4 block. Thus, under the condition of a very large vision change, if INTRA blocks are mainly generated and then the number of INTRA blocks decreases at some moment and INTER blocks or INTER4 blocks are generated more frequently than a first threshold value TH1, it may be considered that a moving person enters the robot's vision. Herein, the first threshold value TH1 may be preset to control the detection sensitivity.

Next, with reference to FIG. 3, a description will be given of a method for the person presence determination unit 60 to determine whether a person is present if a robot moving speed or a camera panning/tilting speed is not high.

If a robot moving speed or a camera panning/tilting speed is not high, there is a high possibility that macro blocks corresponding to a stationary object may be encoded in an INTER block. Because a relatively rigid motion occurs with respect to the camera, there is little possibility that an INTER4 block may occur in a stationary object region. If a portion of a moving person image is included in a macro block, INTER prediction is possible only by smaller-sized block due to a non-rigid motion of a joint such as an arm, a leg, or a finger. Thus, an INTER4 block with two or more motion vectors is generated. When a hidden background appears newly after the movement of the person, such a region may be encoded in an INTRA block. Even if the person is moving at high speed, the macro block may be encoded in an INTRA block. Thus, under the condition of a relatively small vision change, if INTER blocks are mainly generated and then the number of INTER blocks decreases at some moment and INTER4 blocks and INTRA blocks are generated more frequently than a second threshold value TH2, it may be considered that the person is present within the robot's vision. Herein, the second threshold value TH2 may be preset to control the detection sensitivity. The second threshold value TH2 must be set in consideration of the number of INTRA blocks generated forcibly by the CIR settings.

Meanwhile, classification of each status condition is performed and provided by the observation system status input unit 20 in the above process of the person presence determination unit 60.

The person location extraction unit 70 extracts the location of a person. If the person presence determination unit 60 determines that a person is currently present within the robot's vision, the person location extraction unit 70 extracts the location of the person by means of a simple image processing method using the block-mode two-dimensional array obtained by the decoding unit 50. That is, the block-mode two-dimensional array is reflected simply in the vertical direction to calculate a mode frequency of each column.

That is, as illustrated in FIG. 4, under the condition described with reference to FIG. 2 (i.e., if the robot moving speed or the camera panning/tilting speed is high), the person location extraction unit 70 considers that a person image is present in a column where the sum of the frequency of INTER blocks and the frequency of INTER4 blocks is the largest.

Also, as illustrated in FIG. 5, under the condition described with reference to FIG. 3 (i.e., if the robot moving speed or the camera panning/tilting speed is not high), the person location extraction unit 70 considers that a person image is present in a column where the sum of the frequency of INTER4 blocks and the frequency of INTRA blocks is the largest.

It is apparent that the reliability of the two-dimensional array can be increased through morphology such as expansion, erosion and segmentation in addition to the detection of the location of the horizontal direction by means of the frequency per column. Herein, the computation is generally performed in units of 16×16 pixel macro blocks. Since the computation has only to be performed by 1/256 of the expansion/erosion/segmentation computational amount for the number of original pixels, there is little corresponding burden.

Meanwhile, in the present invention, the person presence determination unit 60 and the person location extraction unit 70 will be jointly referred to as a person detection unit. That is, the person detection unit serves to detect the presence and location of a person.

FIG. 6 is a flow diagram illustrating a person detecting method according to an exemplary embodiment. The process illustrated in FIG. 6 is performed by the person detecting apparatus according to the present invention. In the following description, an overlap with the description of the person detecting apparatus made with reference to FIGS. 2 to 5 will be omitted for simplicity.

Before a person detecting process is started, the camera encoding unit 30 of a robot is in basic operation, in which I fame encoding is periodically performed and a CIR value is set to be somewhat high, so that the camera encoding unit 30 can well transmit a camera image to a remote server through a wireless network and can provide against a possible transmission error. Also, an INTER4 mode penalty value is set to achieve an optimal compression ratio.

Meanwhile, the robot must perform a camera panning/tilting operation and/or move to a place where a person may be present, if a normal face detection routine in the stationary status of the observation system or a person recognition routine using the motion vector relationship in a still picture fails. Thus, the observation system (the robot or the camera) starts to move, so that a person detecting process according to the present invention is performed.

If the observation system starts to move, the encoding unit 30 performs a basic setting process that encodes only a P frame, sets CIR to a minimum value, and increases an INTER4 mode penalty value to suppress the generation of an INTER4 block in step 702. At this point, threshold values TH_INTRA, TH1 and TH2 are also set for detection of each person or location.

Thereafter, if an observation status is inputted in step 704, the observation system status input unit 20 determines whether the observation system is stationary in step 706, to change the INTER4 mode penalty value in step 708 or to release the INTER4 mode penalty in step 710.

If the INTER4 mode penalty is released in step 710, all the processes are ended; and if the INTER4 mode penalty value is changed in step 708, the encoding unit 30 uses the value to perform an encoding operation in step 712. The encoding operation of the encoding unit 30 is the same as described above.

The decoding unit 50 receives a bit stream outputted from the encoding unit 30 on a frame basis and decodes the received bit stream in step 714. At this point, a macro block mode value is stored.

The person presence determination unit 60 sets parameters of basic values for person presence determination (i.e., the number of INTRA blocks, the number of INTER blocks, and the number of INTER4 blocks) in step 716 and determines the speed of an observation system in step 718 to perform a process for each case. Herein, the speed of the observation system may be determined on the basis of observation status input or whether the number of INTRA blocks exceeds a threshold value.

As a result of the determination in step 718, if the observation system moves at low speed, INTER blocks are generated throughout the picture as illustrated in FIG. 3, and there is no change in the number of INTER blocks while the observation system is moving at a constant speed. Then, if the number of INTER blocks decreases and the number of INTER4 blocks and the number of INTRA blocks increases and thus a second threshold value TH2 is exceeded in step 720, the person presence determination unit 60 determines that a person is present.

Also, as a result of the determination in step 718, if the observation system moves at high speed, INTRA blocks are generated throughout the picture as illustrated in FIG. 2, and there is no change in the number of INTRA blocks while the observation system is moving at a constant speed. Then, if the number of INTRA blocks decreases and the number of INTER4 blocks and the number of INTER blocks increases and thus a first threshold value TH1 is exceeded in step 722, the person presence determination unit 60 determines that a person is present.

If it is determined that a person is present, the person location extraction unit 70 uses a two-dimensional mode array to detect the location of the person in step 724. Herein, the location of the person is determined in the same manner as explained in the above description of the person location extraction unit 70.

If the location of the person is normally detected through step 724, the person location extraction unit 70 notifies the presence and location of the person to an upper-level controller (e.g., a control unit of the robot) in step 726.

Upon being notified of the presence and location of the person, the upper-level controller (i.e., the control unit of the robot which is not shown) issues a command to stop the movement of the robot and fix the camera toward the location of the person. Thereafter, a person recognition process is performed.

Meanwhile, if the observation system stops, the control unit of the robot restores the INTER4 mode penalty to the original value to change a moving picture compression ratio into a normal value, and resets a moving picture encoder in accordance with the communication state of the server.

As described above, the present invention enables an intelligent mobile robot, which is moving or panning/tilting a camera to detect a person, to determine whether a person is present within its vision and the location of the person. Thus, the intelligent mobile robot, which is moving or panning/tilting the camera to detect a service target person, can detect a person naturally with a small amount of computation without an intentional stop.

Also, the present invention can naturally start an interaction between a robot and a person even in a toy mobile robot and can minimize the execution frequency of a function requiring a large amount of computation, such as face detection, thus making it possible to reduce the power consumption of the intelligent mobile robot.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A person detecting apparatus comprising:
a camera mounted on a robot to output image information;
an observation system status input unit determining whether the robot or the camera is in motion;
an encoding unit receiving the image information to output a bit stream including mode information;
a decoding unit decoding the bit stream, extracting a block mode value of each macro block, and storing the block mode value in a two-dimensional array; and
a person detection unit outputting detection information about a moving person by using the determination information provided from the observation system status input unit and the block-mode two-dimensional array provided from the decoding unit.

2. The person detecting apparatus of claim 1, wherein the observation system status input unit receives information, which affects a viewing direction and the location of a camera origin point, to output information about whether there is a change in the camera origin point or the viewing direction and information about whether the robot is in motion, and provides the outputted information to the encoding unit or the person detection unit.

3. The person detecting apparatus of claim 1, wherein the encoding unit encodes a macro block within a frame of the image information with reference to the previous frame.

4. The person detecting apparatus of claim 1, wherein the encoding unit changes an objective function value of a specific mode such that one of an INTER block and an INTER4 block in a macro block within a frame of the image information occurs more frequently than the other.

5. The person detecting apparatus of claim 1, wherein the encoding unit supports an INTRA mode, an INTER prediction mode, and an INTER4 prediction mode.

6. The person detecting apparatus of claim 1, further comprising a prediction mode determination control unit controlling a tendency of generation of an INTER block and an INTER4 block among the macro block by using information received from the observation system status input unit,
wherein the encoding unit encodes the image information under the control of the prediction mode determination control unit and outputs a bit stream including mode information and a motion vector.

7. The person detecting apparatus of claim 6, wherein the prediction mode determination control unit changes a mode penalty value of the encoding unit to reduce the number of INTER4 blocks if the image is in a panning or tilting status and if the panning/tilting speed is capable of INTER prediction mode encoding.

8. The person detecting apparatus of claim 6, wherein the prediction mode determination control unit sets a mode penalty value of the encoding unit to normally output an INTER4 block if the image is not in a panning or tilting status.

9. The person detecting apparatus of claim 1, wherein the person detection unit comprises:
a person presence determination unit determining whether a moving person image is present in the current image by using the determination information provided from the observation system status input unit and the block-mode two-dimensional array provided from the decoding unit; and
a person location extraction unit extracting the location of the person by using the determination information provided from the observation system status input unit and the block-mode two-dimensional array provided from the decoding unit if the person presence determination unit determines that a person is present.

10. The person detecting apparatus of claim 9, wherein the person presence determination unit determines that a person is present within the robot's vision when the number of INTRA blocks generated in the macro block decreases and the sum of an INTER block and an INTER4 block is greater than a first threshold value in case that the moving speed of the robot or the panning/tilting speed of the camera is high.

11. The person detecting apparatus of claim 9, wherein the person presence determination unit determines that a person is present within the robot's vision when the number of INTER blocks generated in the macro block decreases and the sum of an INTRA block and an INTER4 block is greater than a second threshold value in case that the moving speed of the robot or the panning/tilting speed of the camera is not high.

12. The person detecting apparatus of claim 9, wherein the person location extraction unit determines that a person image is present in a column where the sum of the frequency of INTER blocks and the frequency of INTER4 blocks is the largest in the block-mode two-dimensional array if the moving speed of the robot or the panning/tilting speed of the camera is high.

13. The person detecting apparatus of claim 9, wherein the person location extraction unit determines that a person image is present in a column where the sum of the frequency of INTER4 blocks and the frequency of INTRA blocks is the largest in the block-mode two-dimensional array if the moving speed of the robot or the panning/tilting speed of the camera is not high.

14. A person detecting method comprising:
Receiving, by a person detecting apparatus mounted on a robot, image information from the camera to output a bit stream including mode information upon receipt of movement information related to the movement of a camera or a robot;
decoding, by the person detecting apparatus, the bit stream, extracting a block mode value of each macro block, and storing the block mode value in a two-dimensional array; and
detecting by the person detecting apparatus, a moving person image in a current image to output detection information using the movement information and the block-mode two-dimensional array.

15. The person detecting method of claim 14, wherein the outputting of the detection information comprises:
determining, by the person detecting apparatus, whether a moving person image is present in the current image using the movement information and the block-mode two-dimensional array; and
extracting, by the person detecting apparatus, a location of the person using the movement information and the block-mode two-dimensional array if a moving person image is present in the current image.

16. The person detecting method of claim 15, wherein the determining of the presence of the moving person image in the current image comprises:
determining a moving speed of the camera or the robot using the movement information;
determining that the person is present within the robot's vision when the number of INTRA blocks generated in the macro block decreases and the sum of an INTER block and an INTER4 block is greater than a first threshold value if the moving speed is higher than a reference speed; and
determining that the person is present within the robot's vision when the number of INTER blocks generated in the macro block decreases and the sum of an INTER4 block and an INTRA block is greater than a second threshold value if the moving speed is lower than the reference speed.

17. The person detecting method of claim 15, wherein the extracting of the location of the person comprises:
comparing a moving speed of the camera or the robot, which is calculated from the movement information, to a reference speed if the moving person image is present in the current image;
determining that a person image is present in a column where the sum of the frequency of INTER blocks and the frequency of INTER4 blocks is the largest in the block-mode two-dimensional array if the moving speed is higher than the reference speed; and
determining that a person image is present in a column where the sum of the frequency of INTER4 blocks and the frequency of INTRA blocks is the largest in the block-mode two-dimensional array if the moving speed is lower than the reference speed.
